(19) United States
(12) Patent Application Publication
(10) Pub. No.: US 2016/0171625 A1
(43) Pub. Date: Jun. 16, 2016

(54) Diagram Creating System, Diagram Creating Method, and Program for a Diagram Creating System

(71) Applicant: Hitachi Systems, Ltd., Tokyo (JP)

(72) Inventor: Hideki IKEDA, Yokohama-shi, Kanagawa (JP)

(21) Appl. No.: 14/432,364

(22) PCT Filed: Oct. 17, 2013
(86) PCT No.: PCT/JP2013/078173

§ 371 Date: Mar. 30, 2015

(30) Foreign Application Priority Data
Jun. 20, 2013 (JP) 2013-129477

(51) Int. Cl. G06Q 40/00; G06T 11/20

(52) U.S. Cl. CPC G06Q 40/12; G06T 11/206

(57) ABSTRACT

A diagram creating system, a diagram creating method, and a program for a diagram creating system are provided, with which a vehicle running cost is output along with a transport schedule diagram. The diagram creating system (1) includes: an accounting information storing portion (100); an extracting portion (105) which extracts, from the accounting information storing portion (100), an item related to vehicle running for transportation and accounting information; a quantity adding portion (110) which associates quantity information of an item related to vehicle running for transportation with the item; a unit accounting information calculating portion (115) which calculates unit accounting information; an add-up portion (120) which calculates a total expense per unit quantity; a past vehicle running performance storing portion (125) which stores a moving distance of a transportation machine; a moving distance calculating portion (130) which calculates a unit moving distance per unit quantity; an expense calculating portion (140) which calculates an expense per unit distance; a predicted cost calculating portion (215) which calculates a predicted cost; and an output portion (220) which outputs the predicted cost along with a transport schedule diagram.

### TECHNICAL FIELD

The present invention relates to a diagram creating system, a diagram creating method, and a program for a diagram creating system. The present invention claims priority to Japanese Patent Application No. 2013-129477 filed on Jun. 20, 2013, the contents of which are incorporated herein by reference in designated states where incorporation of literature by reference is allowed.

### BACKGROUND ART

There has hitherto been known a vehicle running system evaluation method in which a reference demand observed when a service of a particular service level is provided is evaluated to subsequently obtain a demand curve for predicting fluctuations in bus utilization demand due to fluctuations in service level and to evaluate the bus utilization demand with the use of the demand curve obtained for each of various service levels, and input resources for achieving the service level in question are evaluated for scheduled vehicle running and on-demand vehicle running each to subsequently evaluate cost effectiveness (see Patent Literature 1, for example). According to the vehicle running system evaluation method of Patent Literature 1, the cost effectiveness of a vehicle running system can be evaluated.

### CITATION LIST

### Patent Literature

[PTL 1] Japanese Patent Laid-open Publication No. 2003-317192

### SUMMARY OF INVENTION

1. Technical Problem

In a vehicle running system evaluation method as the one described in Patent Literature 1, however, cost calculation is not based on actual accounting information and a cost related to concrete vehicle running therefore cannot be calculated. The vehicle running system evaluation method of Patent Literature 1 or a similar method is consequently incapable of telling how much vehicle running in accordance with a given diagram costs by referring to the diagram.

An object of the present invention is therefore to provide a diagram creating system, a diagram creating method, and a program for a diagram creating system with which a vehicle running cost is output along with a transport schedule diagram.

2. Solution to Problem

This patent application includes a plurality of means for attaining at least a part of the object described above, and examples of the means are given as follows. In order to attain the object described above, according to one embodiment of the present invention, there is provided a diagram creating system including: an accounting information storing portion which stores, for each of a plurality of items, a piece of accounting information in association with the each of the plurality of items; an extracting portion which extracts, from the accounting information storing portion, an item related to vehicle running for transportation and a piece of accounting information that is associated with the item related to vehicle running for transportation; a quantity adding portion which associates quantity information of the item related to vehicle running for transportation with the item; a unit accounting information calculating portion which divides the piece of accounting information that is associated with the item related to vehicle running for transportation by the quantity information that is associated with the item, to thereby calculate unit accounting information, which is accounting information per unit quantity of the item related to vehicle running for transportation; an add-up portion which calculates a total expense per unit quantity from a sum of pieces of the unit accounting information; a past vehicle running performance storing portion which stores, for each utilization operation identifier for identifying a utilization operation of a transportation machine, a moving distance of the transportation machine in association with the each utilization operation identifier; a moving distance calculating portion which calculates a total moving distance from a sum of the moving distances stored in the past vehicle running performance storing portion, and divides the total moving distance by a total count of the utilization operation identifiers, to thereby calculate a unit moving distance per unit quantity; an expense calculating portion which divides the total expense by the unit moving distance, to thereby calculate an expense per unit distance; a predicted cost calculating portion which calculates a predicted cost for each utilization operation of the transportation machine in a diagram that illustrates a schedule for running the transportation machine, a transportation machine utilization operation schedule, or a crew shift schedule, or for each of a plurality of vehicle runs included in the utilization operation, by multiplying a planned mileage that is planned in the utilization operation of the transportation machine or the plurality of vehicle runs by the expense per unit distance; and an output portion which outputs the predicted cost along with the diagram.

Further, the diagram creating system described above may further include: a diagram creating portion which creates a diagram illustrating the schedule for running the transportation machine, the transportation machine utilization operation schedule, or the crew shift schedule; and a diagram storing portion which stores a plurality of diagrams created by the diagram creating portion. The predicted cost calculating portion may further calculate the predicted cost for a diagram selected out of the diagram storing portion.

Further, in the diagram creating system described above, the output portion maybe a display device which displays the predicted cost and the diagram, or a printing device which prints the predicted cost and the diagram on a given medium.

Further, in the diagram creating system described above, the diagram may be a “mountain”-format diagram, a bar-format diagram, or a ledger-format diagram.

Further, in the diagram creating system described above, the accounting information storing portion may store the accounting information on a fiscal year basis.

Further, in the diagram creating system described above, the quantity information may be a count of the transportation machines.

Further, in order to attain the object described above, according to one embodiment of the present invention, there is provided an accounting device including: an accounting information storing portion which stores, for each of a plurality of items, a piece of accounting information in association with the each of the plurality of items; an extracting portion which extracts, from the accounting information storing portion, an item related to vehicle running for transportation and a piece of accounting information that is associated with the item; a quantity adding portion which associates quantity information of the item related to vehicle running for transportation with the item; a unit accounting information calculating portion which divides the piece of accounting information that is associated with the item related to vehicle running for transportation by the quantity information that is associated with the item, to thereby calculate unit accounting information, which is accounting information per unit quantity of the item related to vehicle running for transportation; an add-up portion which adds up pieces of the unit accounting information to calculate a total expense per unit quantity; a past vehicle running performance storing portion which stores, for each utilization operation identifier for identifying a utilization operation of a transportation machine, a moving distance of the transportation machine in association with the each utilization operation identifier; a moving distance calculating portion which calculates a total moving distance by adding up the moving distances, and divides the total moving distance by a total count of the utilization operation identifiers, to thereby calculate a unit moving distance per unit quantity; and an expense calculating portion which divides the total expense by the unit moving distance, to thereby calculate an expense per unit distance.

Further, in order to attain the object described above, according to one embodiment of the present invention, there is provided a diagram creating method including: an extracting step of extracting an item related to vehicle running for transportation and a piece of accounting information that is associated with the item related to vehicle running for transportation from an accounting information storing portion which stores, for each of a plurality of items, a piece of accounting information in association with the each of the plurality of items; a quantity adding step of associating quantity information of the item related to vehicle running for transportation with the item; a unit accounting information calculating step of calculating unit accounting information, which is accounting information per unit quantity of the item related to vehicle running for transportation by dividing the piece of accounting information that is associated with the item related to vehicle running for transportation by the quantity information that is associated with the item; an add-up step of calculating a total expense per unit quantity from a sum of pieces of the unit accounting information; a moving distance calculating step of obtaining a sum of moving distances from a past vehicle running performance storing portion which stores, for each utilization operation identifier for identifying a utilization operation of a transportation machine, a moving distance of the transportation machine in association with the each utilization operation identifier, calculating a total moving distance from the sum of moving distances, and dividing the total moving distance by a total count of the utilization operation identifiers, to thereby calculate a unit moving distance per unit quantity; an expense calculating step of calculating an expense per unit distance by dividing the total expense by the unit moving distance; a predicted cost calculating step of calculating a predicted cost for each utilization operation of the transportation machine in a diagram that illustrates a schedule for running the transportation machine, a transportation machine utilization operation schedule, or a crew shift schedule, or for each of a plurality of vehicle runs included in the utilization operation, by multiplying a planned mileage that is planned in the utilization operation of the transportation machine or the plurality of vehicle runs by the expense per unit distance; and an outputting step of outputting the predicted cost along with the diagram.

Further, in order to attain the object described above, according to one embodiment of the present invention, there is provided a program for a diagram creating system, for causing a computer to implement: an extracting function of extracting an item related to vehicle running for transportation and a piece of accounting information that is associated with the item related to vehicle running for transportation from an accounting information storing portion which stores, for each of a plurality of items, a piece of accounting information in association with the each of the plurality of items; a quantity adding function of associating quantity information of the item related to vehicle running for transportation with the item; a unit accounting information calculating function of calculating unit accounting information, which is accounting information per unit quantity of the item related to vehicle running for transportation by dividing the piece of accounting information that is associated with the item related to vehicle running for transportation by the quantity information that is associated with the item; an add-up function of calculating a total expense per unit quantity from a sum of pieces of the unit accounting information; a moving distance calculating function of obtaining a sum of moving distances from a past vehicle running performance storing portion which stores, for each utilization operation identifier for identifying a utilization operation of a transportation machine, a moving distance of the transportation machine in association with the each utilization operation identifier, calculating a total moving distance from the sum of moving distances, and dividing the total moving distance by a total count of the utilization operation identifiers, to thereby calculate a unit moving distance per unit quantity; an expense calculating function of calculating an expense per unit distance by dividing the total expense by the unit moving distance; a predicted cost calculating function of calculating a predicted cost for each utilization operation of the transportation machine in a diagram that illustrates a schedule for running the transportation machine, a transportation machine utilization operation schedule, or a crew shift schedule, or for each of a plurality of vehicle runs included in the utilization operation, by multiplying a planned mileage that is planned in the utilization operation of the transportation machine or the plurality of vehicle runs by the expense per unit distance; and an outputting function of outputting the predicted cost along with the diagram.

3. Advantageous Effects of Invention

With the diagram creating system, the diagram creating method, and the program for a diagram creating system according to one embodiment of the present invention, it is possible to provide the diagram creating system, the diagram creating method, and the program for a diagram creating system with which the vehicle running cost is output along with the transport schedule diagram.

Other objects, configurations, and effects than those described above are revealed through the following description of an embodiment of the present invention.

### BRIEF DESCRIPTION OF DRAWINGS

FIG. 1 is a schematic view of an output screen of a diagram creating system according to an embodiment of the present invention.

FIG. 2 is a schematic view of another output screen of the diagram creating system according to the embodiment of the present invention.

FIG. 3 is a schematic view of still another output screen of the diagram creating system according to the embodiment of the present invention.

FIG. 4 is a function configuration block diagram of the diagram creating system according to the embodiment of the present invention.

FIG. 5 is a function configuration block diagram of an accounting device according to the embodiment of the present invention.

FIG. 6 is a function configuration block diagram of a diagram creating device according to the embodiment of the present invention.

FIG. 7 is a data configuration diagram of an accounting information storing portion according to the embodiment of the present invention.

FIG. 8 is a diagram of a result of adding quantity information by way of a quantity adding portion according to the embodiment of the present invention.

FIG. 9 is a data configuration diagram of a past vehicle running performance storing portion according to the embodiment of the present invention.

FIG. 10 is a flow chart of processing in the diagram creating system according to the embodiment of the present invention.

FIG. 11 is a hardware configuration diagram of the diagram creating system according to the embodiment of the present invention.

### DESCRIPTION OF EMBODIMENT

### Embodiment

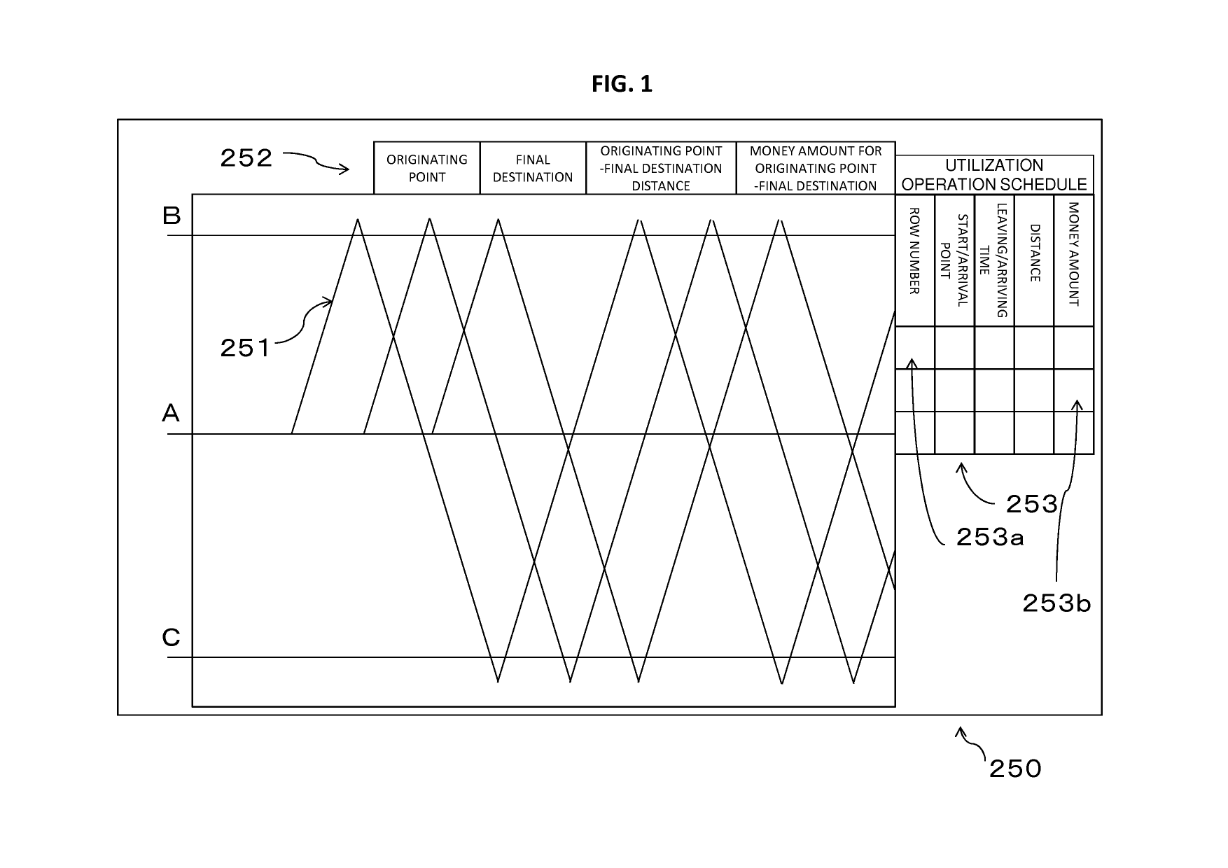

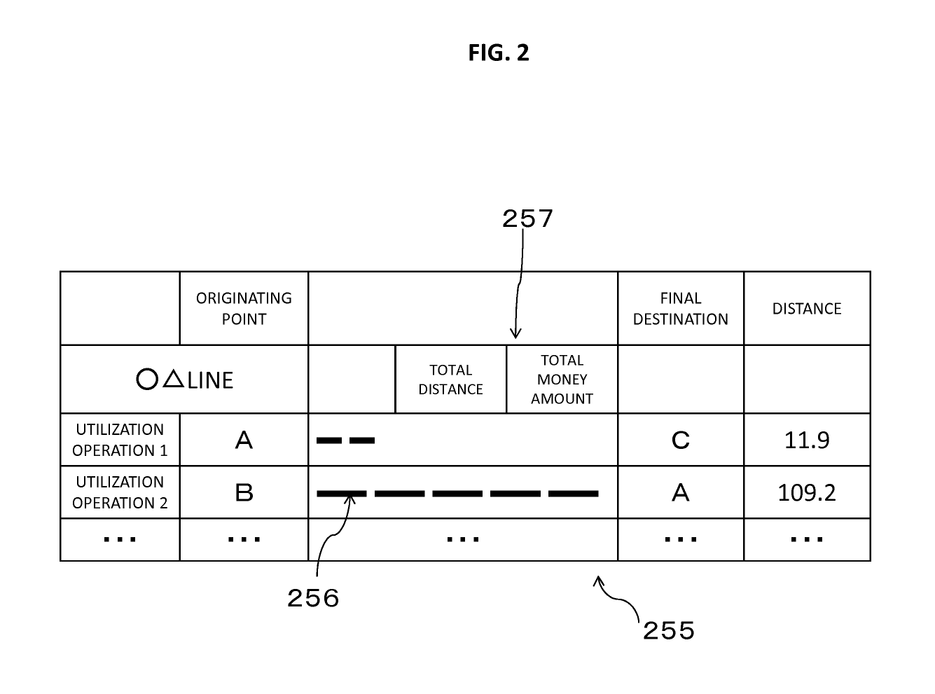

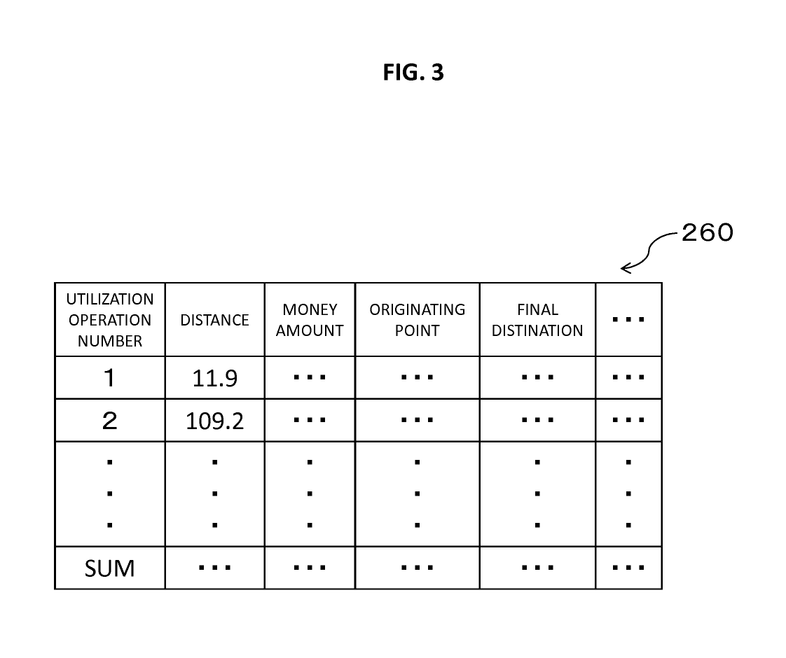

FIGS. 1 to 3 illustrate examples outlining output screens of a diagram creating system according to an embodiment of the present invention. Specifically, FIG. 1 illustrates an example outlining an output screen of a “mountain”-format diagram that is created by the diagram creating system according to the embodiment of the present invention, FIG. 2 illustrates an example outlining an output screen of a bar-format diagram that is created by the diagram creating system according to the embodiment of the present invention, and FIG. 3 illustrates an example outlining an output screen of a ledger-format diagram that is created by the diagram creating system according to the embodiment of the present invention.

(The Outline of a Diagram Creating System 1)

The diagram creating system according to the embodiment of the present invention which is denoted by 1 is a system for calculating, based on accounting information, a cost required for transport that is scheduled at a transport planning stage of public transportation, and for outputting the calculated cost along with a diagram that illustrates a transport schedule of the public transportation in a manner recognizable to users. Specifically, the diagram creating system 1 calculates a cost (i.e., expense) required for running a transportation machine of public transportation per unit moving distance based on accounting information possessed by a corporation or an organization that runs the public transportation. In the planning of a transport schedule, the diagram creating system 1 multiplies a moving distance in each vehicle run that constitutes a utilization operation planned in the transport schedule by the calculated cost per unit moving distance, to thereby calculate a cost required for each vehicle run. The diagram creating system 1 then outputs a cost required for vehicle running, a cost required for utilization operation, a cost required for a transport schedule, or the like along with a transport schedule diagram. Examples of the transportation machine include a train, a subway train, a street car, a cable car, a bus, a ship, an airplane, and a passenger automobile.

For example, the diagram creating system 1 displays, along with a mountain-format diagram 251 of FIG. 1, information about the diagram 251 in display areas 252 and 253 of an output screen 250. An example of what is displayed by the diagram creating system 1 in the display area 252 is the originating point and final destination of one diagram 251 selected by a user or the like, a moving distance between the originating point and the final destination, and an amount of money that is a cost required for public transportation operation represented by the diagram 251 from the originating point to the final destination. An example of what is displayed by the diagram creating system 1 in the display area 253 is table-format information (e.g., a start point, an arrival point, leaving time, arriving time, a distance from the start point to the arrival point, and an amount of money that is a cost required for the run from the start point to the arrival point) of each of one or more vehicle runs that constitute the one diagram 251 selected by a user or the like. For example, information about a first vehicle run constituting the diagram 251 is displayed in a row 253a, and information about a second vehicle run constituting the diagram 251 which differs from the first vehicle run is displayed in a row 253b.

The diagram creating system 1 also displays, along with a bar-format diagram 256 of FIG. 2, information about the diagram in a display area 257 of an output screen 255. For instance, the diagram creating system 1 displays, for each of a plurality of utilization operations, a bar-format diagram of each vehicle run that constitutes the utilization operation on the output screen 255. The diagram creating system 1 also displays for each of a plurality of utilization operations an originating point, a final destination, a distance from the originating point to the final destination, and the like. The diagram creating system 1 displays in the display area 257 the total distance of all utilization operations including “Utilization Operation 1” and “Utilization Operation 2”, and a total amount that is the sum of costs required to run the transportation machine for the total distance.

The diagram creating system 1 is further capable of displaying information about each of a plurality of utilization operations in a ledger format on an output screen 260 as illustrated in FIG. 3. For instance, the diagram creating system 1 can display information about a utilization operation number (e.g., a distance from an originating point to a final destination, an amount of money that is a cost required for a run from the originating point to the final destination, the originating point, and the final destination) in association with the utilization operation number in a ledger format on the output screen 260. The diagram creating system 1 is capable of not only displaying a transport schedule diagram along with a cost that is required to run a vehicle according to the diagram on an output screen but also outputting the diagram and the cost to a given medium. For instance, the diagram creating system 1 can print a transport schedule diagram and a cost that is required to run a vehicle in accordance with the diagram on a printing medium.

(Details of the Diagram Creating System 1)

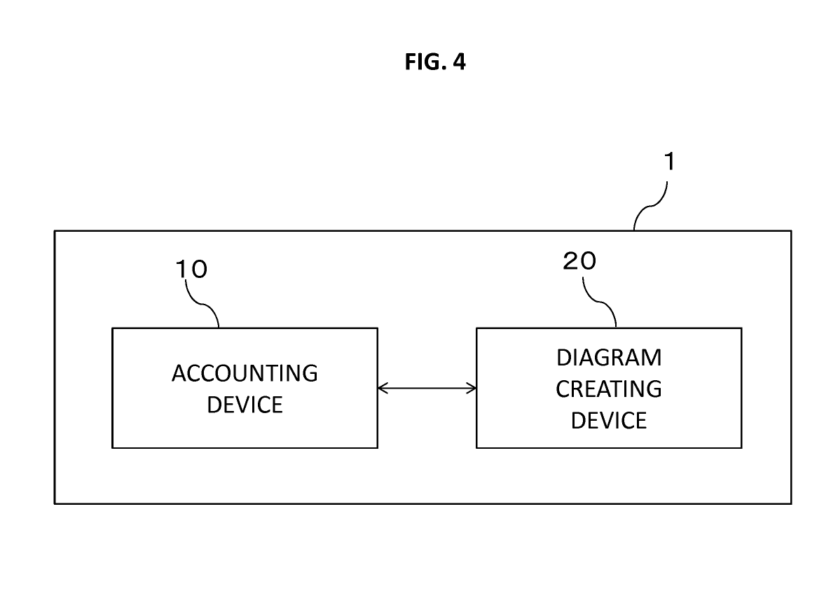

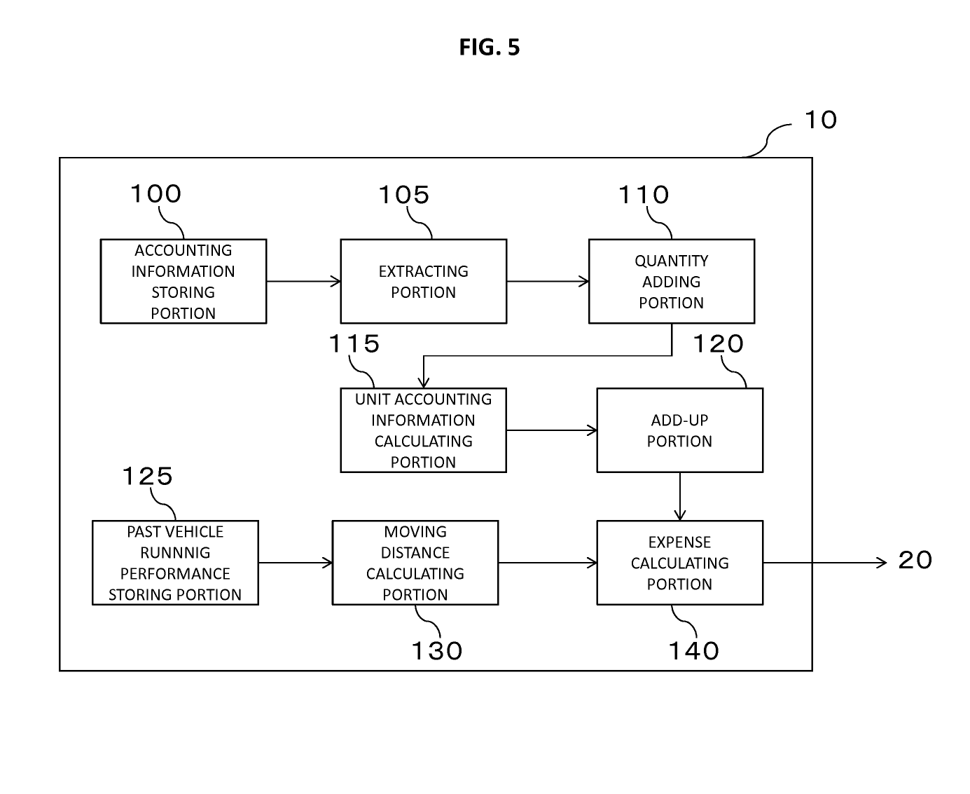

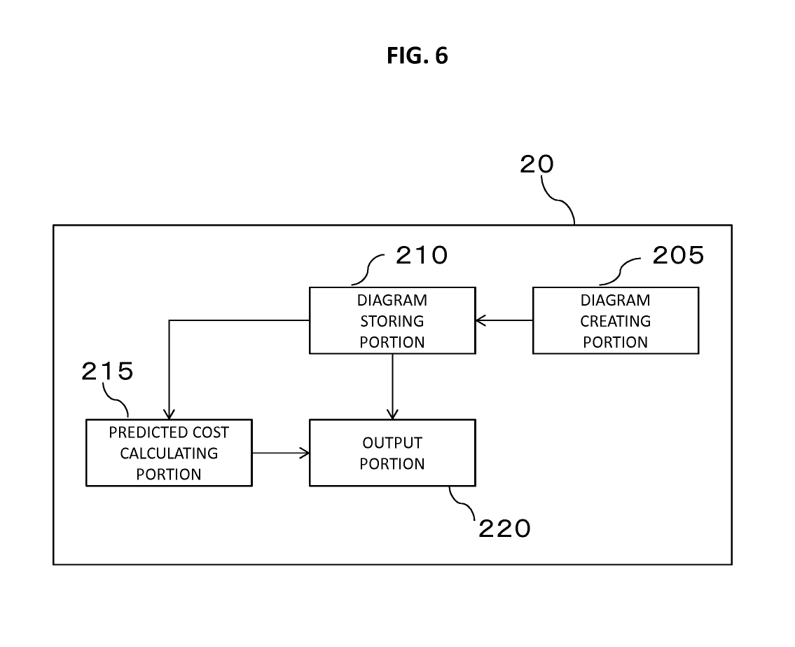

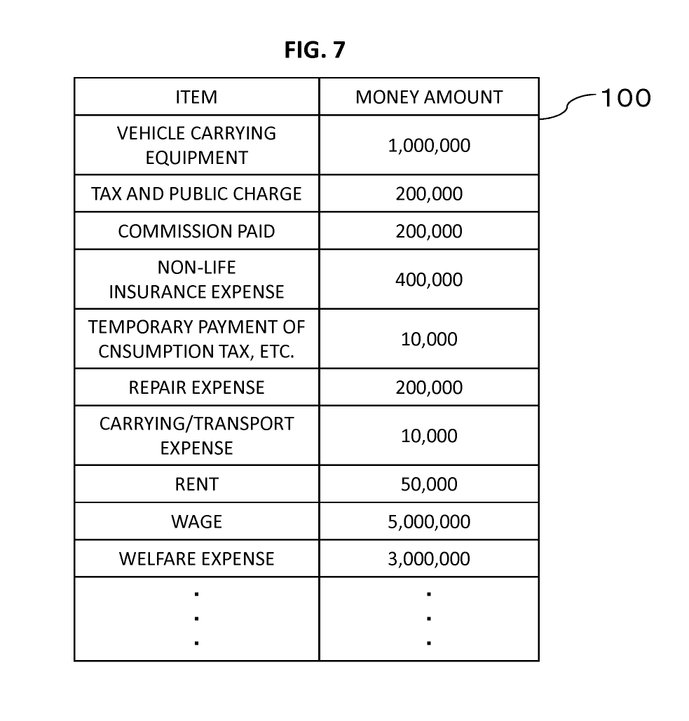

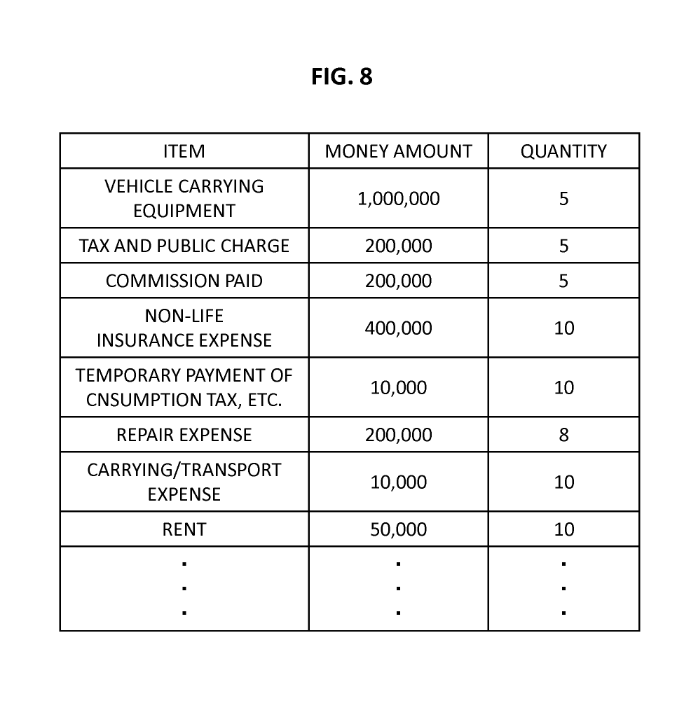

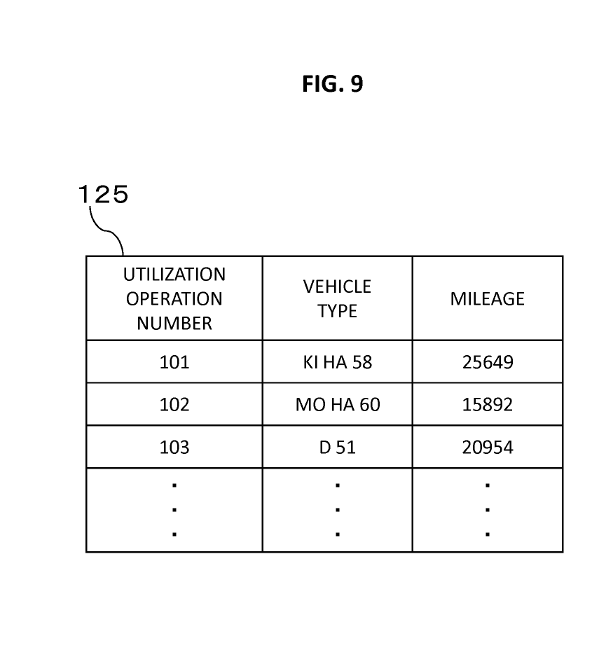

FIG. 4 illustrates an example of a function configuration block of the diagram creating system according to the embodiment of the present invention. FIG. 5 illustrates an example of a function configuration block of an accounting device according to the embodiment of the present invention. FIG. 6 illustrates an example of a function configuration block of a diagram creating device according to the embodiment of the present invention. FIG. 7 illustrates an example of the data configuration of an accounting information storing portion according to the embodiment of the present invention. FIG. 8 illustrates an example of a result of adding quantity information by way of a quantity adding portion according to the embodiment of the present invention. FIG. 9 illustrates an example of the data configuration of a past vehicle running performance storing portion according to the embodiment of the present invention.

The diagram creating system 1 according to this embodiment includes an accounting device 10 which performs data processing on accounting information of a corporation or an organization that is involved in the running of public transportation, and a diagram creating device 20 which creates a diagram illustrating a transport schedule of the public transportation. While the accounting device 10 and the diagram creating device 20 are separate in the description of this embodiment, the accounting device 10 may include a part of or the entirety of the configuration and function of the diagram creating device 20, and the diagram creating device 20 may include a part of or the entirety of the configuration and function of the accounting device 10.

(Accounting Device 10)

The accounting device 10 includes an accounting information storing portion 100 for storing accounting information of a corporation or an organization, an extracting portion 105 for extracting from the accounting information storing portion 100 an item related to the running of a transportation machine for transportation and a piece of accounting information that is associated with the item, and a quantity adding portion 110 for associating an item related to vehicle running for transportation with the quantity of transportation machines that is relevant to the item. The accounting device 10 also includes a unit accounting information calculating portion 115 for calculating unit accounting information which is accounting information per unit quantity of an item related to vehicle running for transportation, and an add-up portion 120 for adding up pieces of unit accounting information that are calculated by the unit accounting information calculating portion 115.

The accounting device 10 further includes a past vehicle running performance storing portion 125 for storing information about the past performance on the running of a transportation machine which is possessed by a corporation or an organization, a moving distance calculating portion 130 for calculating a unit moving distance per unit quantity of transportation machines from past vehicle running performance which is stored in the past vehicle running performance storing portion 125, and an expense calculating portion 140 for calculating a cost that is an expense per unit moving distance of a transportation machine based on an add-up result of the add-up portion 120 and a calculation result of the moving distance calculating portion 130.

(Accounting Information Storing Portion 100)

The accounting information storing portion 100 stores, for each of a plurality of items (i.e., accounting items), a piece of accounting information that is associated with the item (i.e., money amount information which indicates an amount of money), in association with the item. The accounting information storing portion 100 can store accounting information on a fiscal year basis. To give an example, the accounting information storing portion 100 stores a money amount “1,000,000 yen” in association with an item “vehicle carrying equipment”, and stores a money amount “5,000,000 yen” in association with an item “wage” as illustrated in FIG. 7. The accounting information storing portion 100 similarly stores other items in association with amounts of money. In response to a request from the extracting portion 105, the accounting information storing portion 100 supplies a piece of accounting information that is requested by the extracting portion 105 to the extracting portion 105.

(Extracting Portion 105)

The extracting portion 105 extracts from the accounting information storing portion 100 an item related to vehicle running for transportation and a piece of accounting information that is associated with the item related to vehicle running for transportation. For instance, the extracting portion 105 extracts from the accounting information storing portion 100 an item related to vehicle running as the last year's vehicle running for transportation and money amount information that is associated with the item related to vehicle running. The extracting portion 105 supplies the extracted information to the quantity adding portion 110.

(Quantity Adding Portion 110)

The quantity adding portion 110 additionally associates quantity information of an item related to vehicle running for transportation with the item. Quantity information is, for example, the count of transportation machines. In the case where transportation machines in question are buses, for example, the quantity information is the count of buses. Specifically, as illustrated in FIG. 8, the quantity adding portion 110 associates a quantity “5” with an item “vehicle carrying equipment”, and associates a quantity “10” with an item “non-life insurance expense”. To give a more concrete example, when ten vehicles as transportation machines are purchased, the quantity adding portion 110 associates “10” as the quantity information with an item related to vehicle purchase. The quantity adding portion 110 similarly associates other items related to vehicle running for transportation with quantities. The quantity adding portion 110 receives a choice of an item related to vehicle running for transportation and quantity information of the item from a user via, for example, an input device. The quantity adding portion 110 supplies information in which quantity information of an item related to vehicle running for transportation is additionally associated with the item to the unit accounting information calculating portion 115.

(Unit Accounting Information Calculating Portion 115)

The unit accounting information calculating portion 115 calculates unit accounting information which is accounting information per unit quantity of an item related to vehicle running for transportation by dividing a piece of accounting information that is associated with an item related to vehicle running for transportation by a piece of quantity information that is associated with the item. In other words, the unit accounting information calculating portion 115 calculates unit accounting information as information about an amount of money that is spent for one transportation machine during a unit period under one item related to vehicle running for transportation. For each of a plurality of items related to vehicle running for transportation, the unit accounting information calculating portion 115 calculates unit accounting information by dividing a piece of accounting information that is associated with the item related to vehicle running for transportation by a piece of quantity information that is associated with the item. The unit accounting information calculating portion 115 supplies the calculated unit accounting information to the add-up portion 120.

(Add-up Portion 120)

The add-up portion 120 adds up pieces of unit accounting information calculated by the unit accounting information calculating portion 115, to thereby calculate a total expense per unit quantity. In other words, the add-up portion 120 calculates a total cost required during a unit period for the acquisition, maintenance, utilization operation, and the like of one transportation machine. The add-up portion 120 supplies information that indicates the total expense calculated by adding up to the expense calculating portion 140.

(Past Vehicle Running Performance Storing Portion 125)

The past vehicle running performance storing portion 125 stores the moving distance (for example, annual moving distance) of a transportation machine in association with a utilization operation identifier (for example, utilization operation number) by which a utilization operation of the transportation machine is identified. The past vehicle running performance storing portion 125 may also store information that indicates the type of a transportation machine (for example, information indicating a vehicle type in the case where the transportation machine in question is a vehicle such as a train or a bus) in association with a utilization operation identifier by which the transportation machine is identified. For instance, as illustrated in FIG. 9, the past vehicle running performance storing portion 125 stores information that indicates a vehicle type “ki ha 58” and information that indicates a mileage “25,649 km” which is a total distance that a vehicle of the vehicle type in question has traveled the last year in association with a utilization operation number “101”. In response to a request from the moving distance calculating portion 130, the past vehicle running performance storing portion 125 supplies information requested by the moving distance calculating portion 130 to the moving distance calculating portion 130. The past vehicle running performance storing portion 125 may store identification information for uniquely identifying a transportation machine in place of, or in addition to, the vehicle type.

(Moving Distance Calculating Portion 130)

The moving distance calculating portion 130 calculates an annual or fiscal total moving distance from the sum of moving distances stored in the past vehicle running performance storing portion 125, and divides the total moving distance by the total count of utilization operation identifiers to calculate a unit moving distance per unit quantity. In other words, the moving distance calculating portion 130 calculates an average value of the annual moving distance of one transportation machine owned by a corporation or an organization, such as a bus. The moving distance calculating portion 130 supplies information that indicates the calculated unit moving distance to the expense calculating portion 140.

(Expense Calculating Portion 140)

The expense calculating portion 140 divides the information indicating a total expense which is received from the add-up portion 120 by the unit moving distance which is received from the moving distance calculating portion 130, to thereby calculate an expense required per unit distance. The expense calculating portion 140 calculates an expense required for the traveling of a transportation machine owned by a corporation or an organization, such as a bus, for a unit distance (1 km, for example) in this manner. The expense calculating portion 140 supplies information that indicates the calculated expense per unit distance to a predicted cost calculating portion 215.

(Diagram Creating Device 20)

The diagram creating device 20 includes a diagram creating portion 205 for creating a diagram, a diagram storing portion 210 for storing a plurality of diagrams, the predicted cost calculating portion 215 for calculating the annual cost of one utilization operation illustrated by a diagram, or the respective annual costs of a plurality of utilization operations illustrated by a plurality of diagrams, and an output portion 220 for outputting the result of the calculation performed by the predicted cost calculating portion 215 along with a relevant diagram.

(Diagram Creating Portion 205)

The diagram creating portion 205 creates a diagram that illustrates a transportation machine running schedule, a utilization operation schedule of a transportation machine, a crew shift schedule, or the like. The diagram creating portion 205 creates, for example, a diagram that contains one or more utilization operations each constituted of one or more vehicle runs. To give an example, the diagram creating portion 205 can create a mountain-format diagram for a vehicle running schedule and a bar-format diagram for a vehicle utilization operation schedule. The diagram creating portion 205 is also capable of creating a ledger-format diagram. The diagram creating portion 205 supplies the created diagram to the diagram storing portion 210.

(Diagram Storing Portion 210)

The diagram storing portion 210 stores one or more diagrams created by the diagram creating portion 205. The diagram storing portion 210 supplies a diagram to the predicted cost calculating portion 215 in response to a request from the predicted cost calculating portion 215. The predicted cost calculating portion 215 supplies the diagram to the output portion 220 in response to a request from the output portion 220.

(Predicted Cost Calculating Portion 215) For each transportation machine utilization operation in a diagram that illustrates a transportation machine running schedule, a transportation machine utilization operation schedule, a crew shift schedule, or the like, or for each of one or more vehicle runs included in the utilization operation, the predicted cost calculating portion 215 calculates a predicted cost which is calculated by multiplying a planned mileage by an expense per unit distance. A planned mileage is a moving distance planned in a transportation machine utilization operation, or one or more transportation machine runs. In short, the predicted cost calculating portion 215 calculates a predicted cost for a diagram selected out of the diagram storing portion 210. The predicted cost calculating portion 215 calculates a predicted cost for each of one or more utilization operations that are contained in one diagram, or for each of one or more vehicle runs that constitute one utilization operation. Alternatively, the predicted cost calculating portion 215 calculates a predicted total cost of one or more utilization operations that constitute a transport schedule.

For example, from a diagram selected by a user or the like via an input device or the like, the predicted cost calculating portion 215 extracts the moving distance of one utilization operation contained in the diagram (i.e., a distance between the originating point and final destination of the one utilization operation). The predicted cost calculating portion 215 then calculates a cost predicted to be necessary for the extracted moving distance by multiplying the moving distance by an expense per unit distance.

The predicted cost calculating portion 215 also extracts, for each of one or more vehicle runs that constitute one utilization operation contained in a diagram, the moving distance of the vehicle run (i.e., a distance from a start point to an arrival point). The predicted cost calculating portion 215 then calculates, for each of the one or more vehicle runs, a cost predicted to be necessary for the vehicle run by multiplying the extracted moving distance by an expense per unit distance.

The predicted cost calculating portion 215 further calculates, for each of one or more utilization operations that are contained in one diagram, a cost required for the utilization operation by multiplying the moving distance of the utilization operation by an expense per unit distance. The predicted cost calculating portion 215 then adds up the one or more calculated costs, to thereby calculate a predicted total cost that covers all of the one or more utilization operations. The predicted cost calculating portion 215 supplies information that indicates the calculated predicted cost and the extracted moving distance to the output portion 220 in association with each utilization operation or each vehicle run. Alternatively, the predicted cost calculating portion 215 supplies the predicted total cost and the total moving distance to the output portion 220.

(Output portion 220)

The output portion 220 outputs a predicted cost which is associated with a utilization operation or a vehicle run, along with a diagram illustrating the utilization operation or the vehicle run. The output portion 220 also outputs, along with the diagram, such information as the name of an originating point, the name of a final destination, and a distance from the originating point to the final destination. The output portion 220 is specifically a display device for displaying a predicted cost and a diagram, or a printing device for printing a predicated cost and a diagram on a given medium. To give an example, the output portion 220 outputs a predicted cost and a diagram together in one of the formats illustrated in FIGS. 1 to 3. The output portion 220 can also output a predicted cost along with a diagram in a format suited to an external output instruction in response to the output instruction.

(Processing Flow of the Diagram Creating System 1)

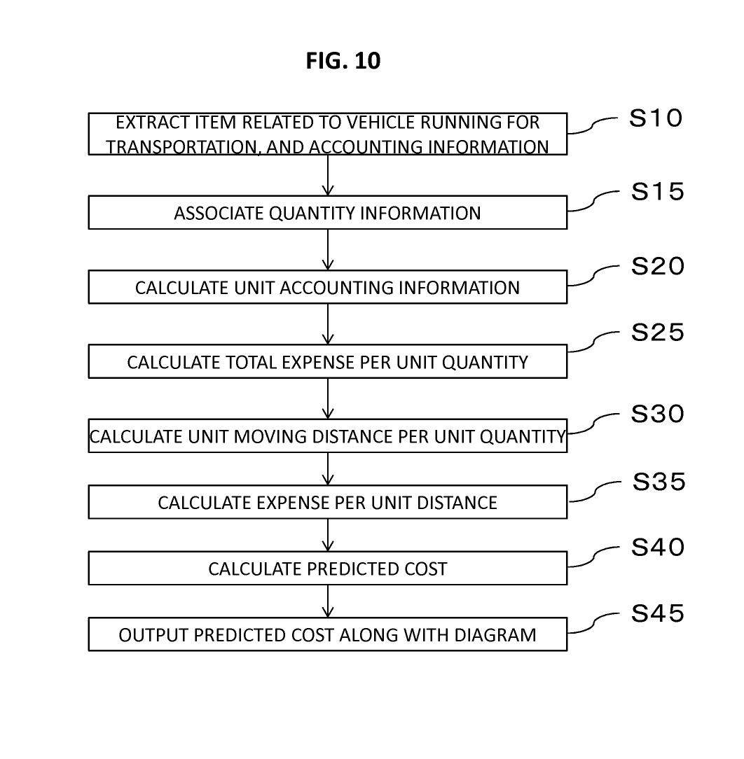

FIG. 10 illustrates an example of the processing flow in the diagram creating system according to the embodiment of the present invention.

First, the extracting portion 105 extracts an item related to vehicle running for transportation, and a piece of accounting information that is associated with the item related to vehicle running for transportation, from the accounting information storing portion 100 (Step 10. “Step” is hereinafter abbreviated as “S”). The extracting portion 105 supplies the extracted information to the quantity adding portion 110. For each of a plurality of items related to vehicle running for transportation that is received from the extracting portion 105, the quantity adding portion 110 associates a piece of quantity information with the item (S15). The quantity adding portion 110 supplies information with which quantity information is associated to the unit accounting information calculating portion 115.

The unit accounting information calculating portion 115 calculates unit accounting information which is accounting information per unit quantity of an item related to vehicle running for transportation (S20). The unit accounting information calculating portion 115 supplies the calculated unit accounting information to the add-up portion 120. The add-up portion 120 adds up pieces of unit accounting information received from the unit accounting information calculating portion 115 to calculate a total expense per unit quantity (S25). The add-up portion 120 supplies information that indicates the calculated total expense to the expense calculating portion 140.

Meanwhile, the moving distance calculating portion 130 calculates, for example, a fiscal total moving distance from the sum of moving distances stored in the past vehicle running performance storing portion 125. The moving distance calculating portion 130 then calculates a moving distance per transportation machine (i.e., unit moving distance) based on the calculated total moving distance and the total count of transportation machines (i.e., the total count of utilization operation identifiers) (S30). The moving distance calculating portion 130 supplies information that indicates the calculated unit moving distance to the expense calculating portion 140.

The expense calculating portion 140 calculates an expense per unit distance based on the information indicating a total expense which is received from the add-up portion 120 and the information indicating a unit moving distance which is received from the moving distance calculating portion 130 (S35). The expense calculating portion 140 supplies information that indicates the calculated expense per unit distance to the predicted cost calculating portion 215. The predicted cost calculating portion 215 multiplies the moving distance of a transportation machine that is illustrated in a diagram stored in the diagram storing portion 210, or a diagram selected out of the diagram storing portion 210, by the expense per unit distance which is received from the expense calculating portion 140, to thereby calculate a predicted cost (S40). The predicted cost calculating portion 215 supplies the calculated predicted cost to the output portion 220. The output portion 220 outputs the predicted cost along with the diagram (S45).

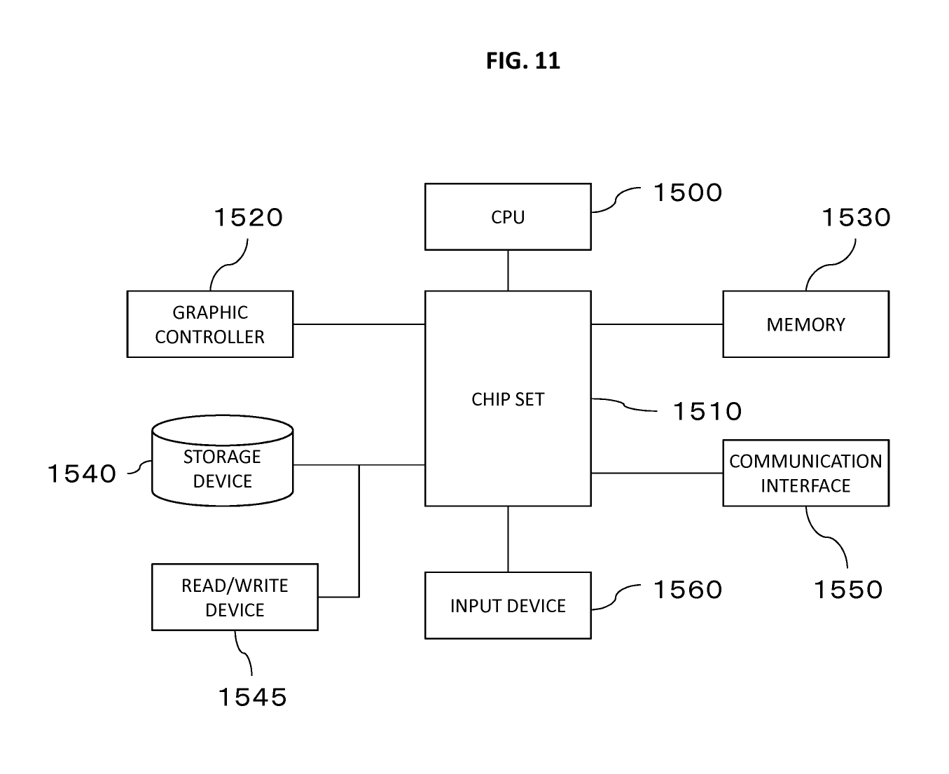

FIG. 11 illustrates an example of the hardware configuration of the diagram creating system according to the embodiment of the present invention.

The diagram creating system 1 according to this embodiment includes a CPU 1500, a graphic controller 1520, a memory 1530 which is a random access memory (RAM), a read-only memory (ROM), and/or a flash ROM or the like, a storage device 1540 which stores data, a read/write device 1545 which reads data out of a recording medium and/or writes data in a recording medium, an input device 1560 which inputs data, a communication interface 1550 which transmits/receives data to/from an external communication device, and a chip set 1510 which connects the CPU 1500, the graphic controller 1520, the memory 1530, the storage device 1540, the read/write device 1545, the input device 1560, and the communication interface 1550 to one another in a manner that allows communication.

The chip set 1510 executes the handing over of data between components by interconnecting the memory 1530, the CPU 1500 which accesses the memory 1530 to execute given processing, and the graphic controller 1520 which controls what is displayed on an external display device. The CPU 1500 operates as programmed by a program stored in the memory 1530 to control the components. The graphic controller 1520 displays an image on a given display device based on image data temporarily stored in a buffer that is provided in the memory 1530.

The chip set 1510 also connects the storage device 1540, the read/write device 1545, and the communication interface 1550. The storage device 1540 stores a program and data that are used by the CPU 1500 of the diagram creating system 1 . The storage device 1540 is a flash memory, for example. The read/write device 1545 reads a program and/or data out of a recording medium storing a program and/or data, and stores the read program and/or data in the storage device 1540. The read/write device 1545 obtains, for example, a given program from a server on the Internet via the communication interface 1550, and stores the obtained program in the storage device 1540.

The communication interface 1550 executes data transmission/reception to/from an external device via a communication network. The communication interface 1550 can also execute data transmission/reception to/from an external device without the intervention of a communication network when the communication network is disconnected. The input device 1560 is a tablet, a microphone, or the like and connects to the chip set 1510 via a given interface.

A program for the diagram creating system 1 to be stored in the storage device 1540 is provided to the storage device 1540 via a communication network such as the Internet, or via a recording medium such as a magnetic recording medium or an optical recording medium. Once stored in the storage device 1540, the program for the diagram creating system 1 is executed by the CPU 1500.

The program for the diagram creating system 1 which is executed by the diagram creating system 1 according to this embodiment operates the CPU 1500 so that the diagram creating system 1 functions as the accounting information storing portion 100, the extracting portion 105, the quantity adding portion 110, the unit accounting information calculating portion 115, the add-up portion 120, the past vehicle running performance storing portion 125, the moving distance calculating portion 130, the expense calculating portion 140, the diagram creating portion 205, the diagram storing portion 210, the predicted cost calculating portion 215, and the output portion 220 which have been described with reference to FIGS. 1 to 10.

(Effects of the Embodiment)

The diagram creating system 1 according to this embodiment is capable of calculating, from accounting information, a cost predicted to be necessary for the running of a transportation machine which is associated with a given diagram, and outputting the predicted cost along with the diagram in a manner recognizable to users. The diagram creating system 1 thus enables a person in charge of transport schedule to grasp a predicted cost with ease, and can help a corporation or an organization to make an optimum investment plan.

The embodiment of the present invention has now been described. However, the embodiment described above is not to limit the invention set forth in Scope of Claims. It should also be noted that not all of combinations of the features described in the embodiment are indispensable to means for attaining the object of the invention. Moreover, technical elements of the embodiment described above may each be applied alone, or may be applied divided into a plurality of parts such as program parts and hardware parts.

### REFERENCE SIGNS LIST

1 diagram creating system

10 accounting device

20 diagram creating device

100 accounting information storing portion

105 extracting portion

110 quantity adding portion

115 unit accounting information calculating portion

120 add-up portion

125 past vehicle running performance storing portion

130 moving distance calculating portion

140 expense calculating portion

205 diagram creating portion

210 diagram storing portion

215 predicted cost calculating portion

220 output portion

250 output screen

251 diagram

252, 253 display area

255 output screen

256 diagram

257 display area

260 output screen

1500 CPU

1510 chip set

1520 graphic controller

1530 memory

1540 storage device

1545 read/write device

1550 communication interface

1560 input device

1-9. (canceled)

10. A diagram creating system, comprising:
an accounting information storing portion which stores, for each of a plurality of items, a piece of accounting information in association with the each of the plurality of items;
an extracting portion which extracts, from the accounting information storing portion, an item related to vehicle running for transportation and a piece of accounting information that is associated with the item related to vehicle running for transportation;
a quantity adding portion which associates quantity information of the item related to vehicle running for transportation with the item;
a unit accounting information calculating portion which divides the piece of accounting information that is associated with the item related to vehicle running for transportation by the quantity information that is associated with the item, to thereby calculate unit accounting information, which is accounting information per unit quantity of the item related to vehicle running for transportation;
an add-up portion which calculates a total expense per unit quantity from a sum of pieces of the unit accounting information;
a past vehicle running performance storing portion which stores, for each utilization operation identifier for identifying a utilization operation of a transportation machine, a moving distance of the transportation machine in association with the each utilization operation identifier;
a moving distance calculating portion which calculates a total moving distance from a sum of the moving distances stored in the past vehicle running performance storing portion, and divides the total moving distance by a total count of the utilization operation identifiers, to thereby calculate a unit moving distance per unit quantity;
an expense calculating portion which divides the total expense by the unit moving distance, to thereby calculate an expense per unit distance;
a predicted cost calculating portion which calculates a predicted cost for each utilization operation of the transportation machine in a diagram that illustrates a schedule for running the transportation machine, a transportation machine utilization operation schedule, or a crew shift schedule, and for each of a plurality of vehicle runs comprised in the utilization operation, by multiplying a planned mileage that is planned in the utilization operation of the transportation machine and the plurality of vehicle runs by the expense per unit distance; and
an output portion which outputs an output screen comprising the diagram, a first display area to display the predicted cost of the utilization operation in the diagram, and a second display area to display the predicted cost for each of the plurality of vehicle runs comprised in the utilization operation in the diagram.

11. A diagram creating system according to claim 10, further comprising:
a diagram creating portion which creates a diagram illustrating the schedule for running the transportation machine, the transportation machine utilization operation schedule, or the crew shift schedule; and
a diagram storing portion which stores a plurality of diagrams created by the diagram creating portion,
wherein the predicted cost calculating portion calculates the predicted cost for a diagram selected out of the diagram storing portion.

12. A diagram creating system according to claim 11, wherein the output portion comprises a display device which displays the predicted cost and the diagram, or a printing device which prints the predicted cost and the diagram on a given medium.

13. A diagram creating system according to claim 10, wherein the diagram comprises a “mountain”-format diagram, a bar-format diagram, or a ledger-format diagram.

14. A diagram creating system according to claim 10, wherein the accounting information storing portion stores the accounting information on a fiscal year basis.

15. A diagram creating system according to claim 10, the quantity information comprises a count of the transportation machines.

16. A diagram creating method, comprising:
an extracting step of extracting an item related to vehicle running for transportation and a piece of accounting information that is associated with the item related to vehicle running for transportation from an accounting information storing portion which stores, for each of a plurality of items, a piece of accounting information in association with the each of the plurality of items;
a quantity adding step of associating quantity information of the item related to vehicle running for transportation with the item;
a unit accounting information calculating step of calculating unit accounting information, which is accounting information per unit quantity of the item related to vehicle running for transportation by dividing the piece of accounting information that is associated with the item related to vehicle running for transportation by the quantity information that is associated with the item;
an add-up step of calculating a total expense per unit quantity from a sum of pieces of the unit accounting information;
a moving distance calculating step of obtaining a sum of moving distances from a past vehicle running performance storing portion which stores, for each utilization operation identifier for identifying a utilization operation of a transportation machine, a moving distance of the transportation machine in association with the each utilization operation identifier, calculating a total moving distance from the sum of moving distances, and dividing the total moving distance by a total count of the utilization operation identifiers, to thereby calculate a unit moving distance per unit quantity;
an expense calculating step of calculating an expense per unit distance by dividing the total expense by the unit moving distance;
a predicted cost calculating step of calculating a predicted cost for each utilization operation of the transportation machine in a diagram that illustrates a schedule for running the transportation machine, a transportation machine utilization operation schedule, or a crew shift schedule, and for each of a plurality of vehicle runs comprised in the utilization operation, by multiplying a planned mileage that is planned in the utilization operation of the transportation machine and the plurality of vehicle runs by the expense per unit distance; and
an outputting step of outputting an output screen comprising the diagram, a first display area to display the predicted cost of the utilization operation in the diagram, and a second display area to display the predicted cost for each of the plurality of vehicle runs comprised in the utilization operation in the diagram.

17. (canceled)
